(19) United States
(12) Patent Application Publication
(10) Pub. No.: US 2004/0177282 A1
(43) Pub. Date: Sep. 9, 2004

(54) Method and circuit for controlling battery charge and supply by microprocessor

(75) Inventor: Ching Chang Twu, Yungho City (TW)

Correspondence Address: BACON & THOMAS, PLLC, 625 SLATERS LANE, FOURTH FLOOR, ALEXANDRIA, VA, 22314

(73) Assignee: ZONE TECHNOLOGY INC., Taipei (TW)

(21) Appl. No.: 10/379,697

(22) Filed: Mar. 6, 2003

(51) Int. Cl. G06F 1/26

(52) U.S. Cl. 713/300

(57) ABSTRACT

The present invention discloses a method and a circuit for controlling a battery charge and supply by a microprocessor, in which a microprocessor is connected individually to a charging circuit, a DC voltage circuit, and a power supply circuit; a pair of chargeable batteries is set between the charging circuit and the DC voltage circuit such that if the microprocessor detects one of the batteries having a larger power than the other battery, the microprocessor will control the charging circuit to charge the battery having lesser power until the microprocessor detects the level of charge of the charging battery is lower than the standard electric level in order to achieve the purpose of maximizing the utility of the battery and accurately controlling the power supply through the control of the microprocessor.

### BACKGROUND OF THE INVENTION

1. Field of the Invention

The present invention relates to a method and a circuit for controlling a battery charge and supply by a microprocessor.

2. Description of the Related Art

Please refer to FIG. 1 for a traditional electric charging circuit. The circuit 1 comprises a charge circuit 11 and a supply circuit 13, wherein a pair of chargeable batteries 15 is set between the charge circuit 11 and the power supply circuit 13, and a switch circuit 16 is set between the chargeable batteries 15 and the charge circuit 11, and the power supply circuit 13 has a pair of one-way current restricting diodes 131 such that the power of the chargeable batteries 15 flows smoothly to the electronic device 17 (such as a computer) connected to a power supply circuit 13, and the current on the electronic device 17 will not flow back to the chargeable batteries 15 and damage the chargeable batteries 15, so that when the power supply of such electronic device 17 charges the chargeable batteries 15, the chargeable batteries 15 can connect or disconnect the circuit via the switch circuit 16 for charging or supply power to the electronic device 17. However, such prior-art power supply circuit is unable to efficiently control the flow of power supply to the chargeable batteries 15, and the impedance of the diode 131 will also lower the voltage of the electric power released by the chargeable batteries 15, and it is unable to reach the expected power supply voltage. In the meantime, the chargeable batteries 15 aging after being used for a while should be replaced. The system of supplying/charging the power supply must be turned off before another set of batteries is replaced. It causes inconvenience to the application, particularly when the charging target is a computer; it may easily cause data loss while the computer is processing data and too late to save or back up the data.

### SUMMARY OF THE INVENTION

The primary objective of the present invention is to provide a method and circuit for controlling the battery charge and supply by a microprocessor, of which the microprocessor is connected individually to a charging circuit, a DC voltage circuit, and a power supply circuit, and a pair of chargeable batteries is set between the charging circuit and the DC voltage circuit such that if the microprocessor detects that one of the batteries has larger power than the other battery, the microprocessor will control the charging circuit to charge the battery having lesser power until the microprocessor detects the level of charge of the charging batter is lower than the standard electricity level, and respectively control the charging circuit and the power supply circuit to charge the battery having a power level lower than the standard electricity level while supplying electric power to the charging battery for the power supply. Such repeated charging and supplying procedure can achieve the purpose of maximizing the utility of the battery and accurately controlling the power supply through the control of the microprocessor.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is a circuit diagram of a prior-art power supply and charging circuit.

FIG. 2 is a circuit diagram of the present invention.

FIGS. 3A, 3B and 3C are a flow chart of the present invention.

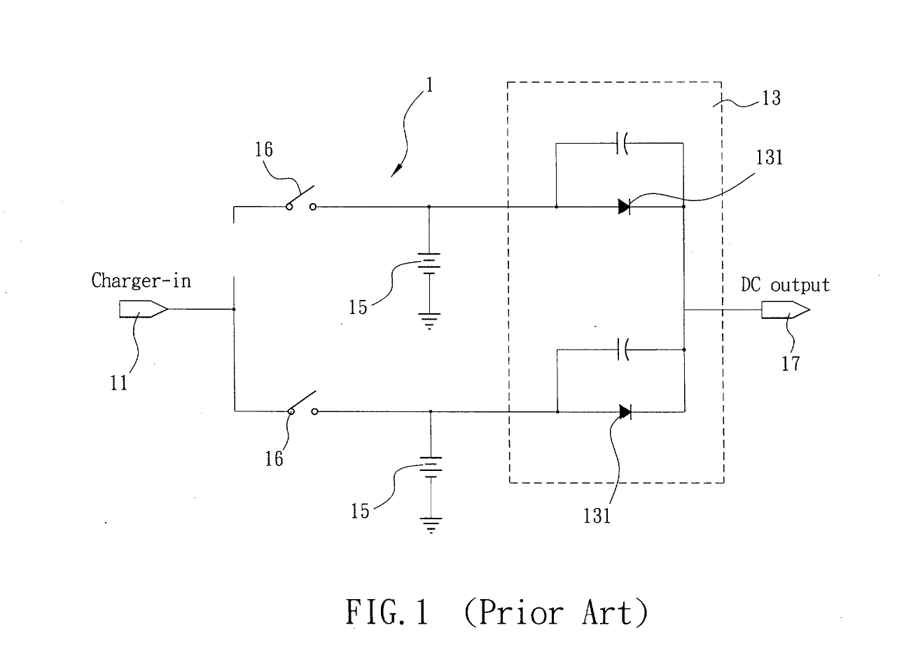

### DETAILED DESCRIPTION OF THE PREFERRED EMBODIMENTS

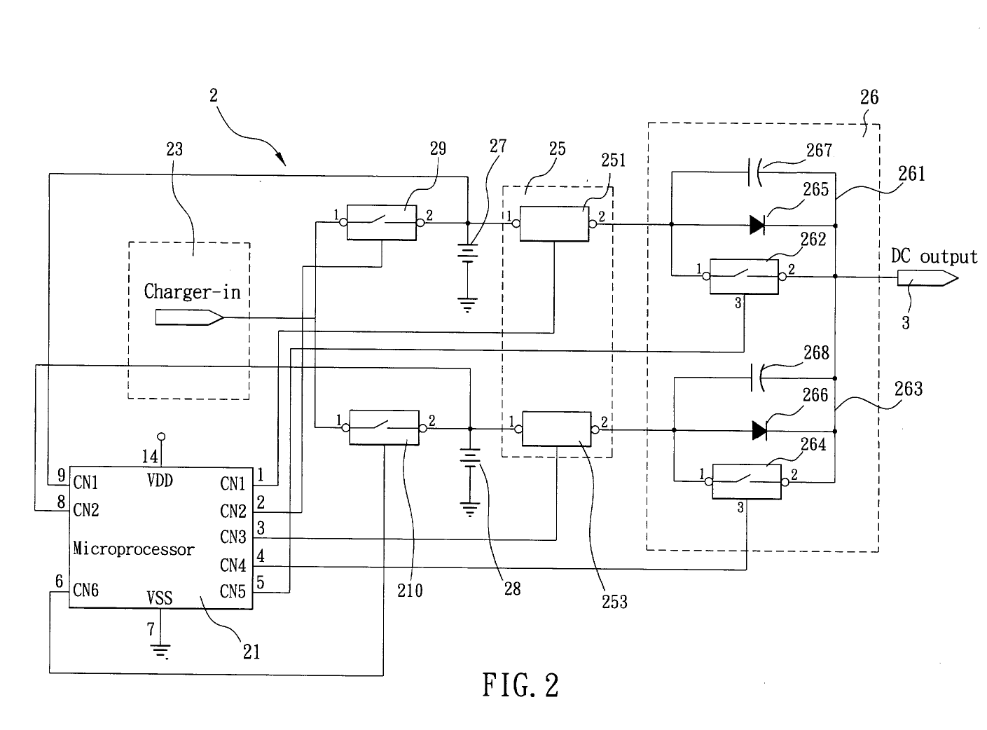

Please refer to the FIG. 2 for a method and a circuit for controlling a battery charge and supply by a microprocessor in accordance to the present invention. Said circuit 2 comprises a microprocessor 21, and the microprocessor 21 is connected in sequence with a charging circuit 23, a DC voltage circuit 25, and a power supply circuit 26, wherein a first chargeable battery 27 and a second chargeable battery 28 are set between the charging circuit 23 and the DC voltage circuit 25, and the chargeable batteries 27, 28 are connected to the microprocessor 21, such that the microprocessor 21 can detect the electricity level of the chargeable batteries 27, 28. A first charging switch 29 and a second charging switch 210 are set between the chargeable batteries 27, 28 and the charging circuit 23, and the first and second charging switches 29, 210 are connected to the microprocessor 21, so that the microprocessor 21 can separately control the first and second charging switches 29, 210 to ON or OFF status and the charging circuit 23 charges the first chargeable battery 27 or charges the second chargeable battery 28.

Please refer to FIG. 2 again. The DC voltage circuit 25 comprises a first DC voltage circuit 251 and a second DC voltage circuit 253, wherein the first and second DC voltage circuits 251, 253 respectively connect to the first and second chargeable batteries 27, 28 such that the voltage of the electric power released by the first and second chargeable batteries 27, 28 can be stabilized by the first and second DC voltage circuits 251, 253 and the electric power is supplied to an electronic device 3 (such as a computer) connected to the power supply circuit 26.

Please refer to FIG. 2 again. The power supply circuit 26 comprises a first power supply circuit 261 and a second power supply circuit 263, and the power supply, and the power supply circuits 261, 263 each comprises a one-way current limiting diode 265, 266 and a capacitor 267, 268, wherein the diodes 265, 266 and the capacitors 267, 268 are connected in series, and the diodes 265, 266 can prevent the electricity of the electronic device 3 from flowing back to first and second chargeable batteries 27, 28 and avoid electric short circuit of the first and second chargeable batteries 27, 28 due to the backflow of the electric current. The diodes 265, 266 are connected to a first power supply switch 262 and a second power supply switch 264 in series, and the first and second power supply switches 262, 264 are also connected the microprocessor 21, such that the microprocessor 21 can control the first and second power supply switches 262, 264 to the ON/OFF status, and makes uses the property of electricity selecting to pass through a conductor with lower resistance to supply electric power to the electronic device 3 from the first and second chargeable batteries 27, 28. The electric current will not pass through the diodes 265, 266 with higher resistance, and will not lower the voltage.

Further, when the first and second chargeable batteries 27, 28 age after being used for a while, the basic electric level of the first and second chargeable batteries 27, 28 is lower than the minimum electric power of regular battery, such circuit 2 allows the direct replacement of the first chargeable battery 27 or the second chargeable battery 28 without turning off the power, or interrupting the power supply to the electronic device 3.

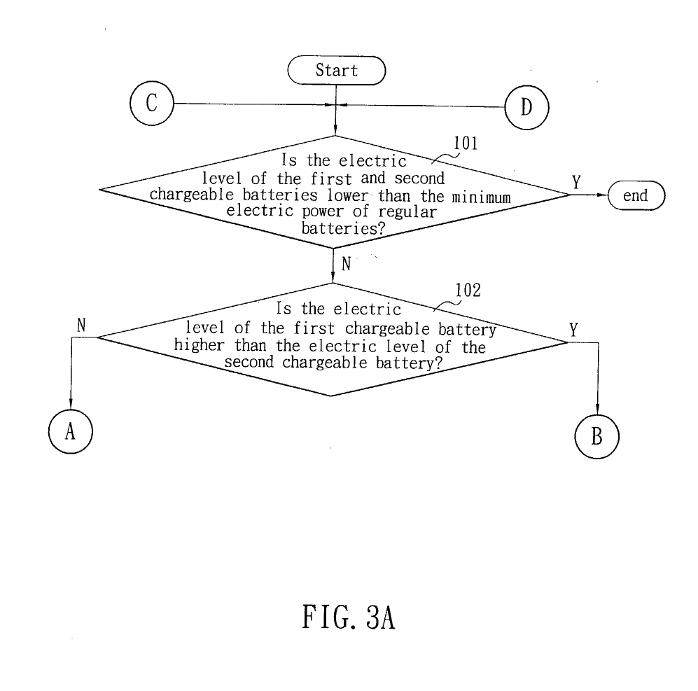

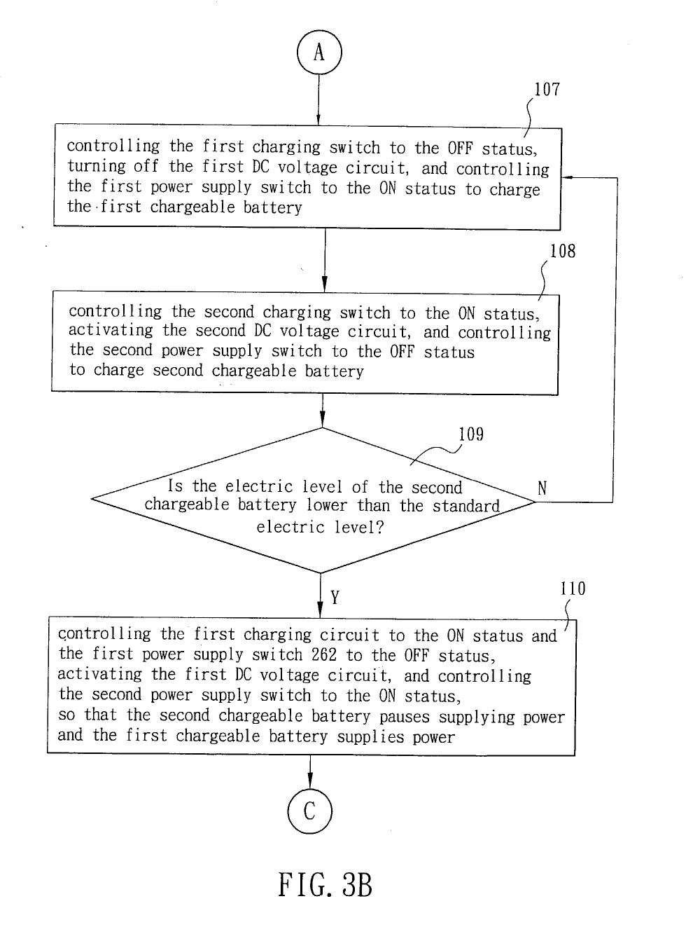

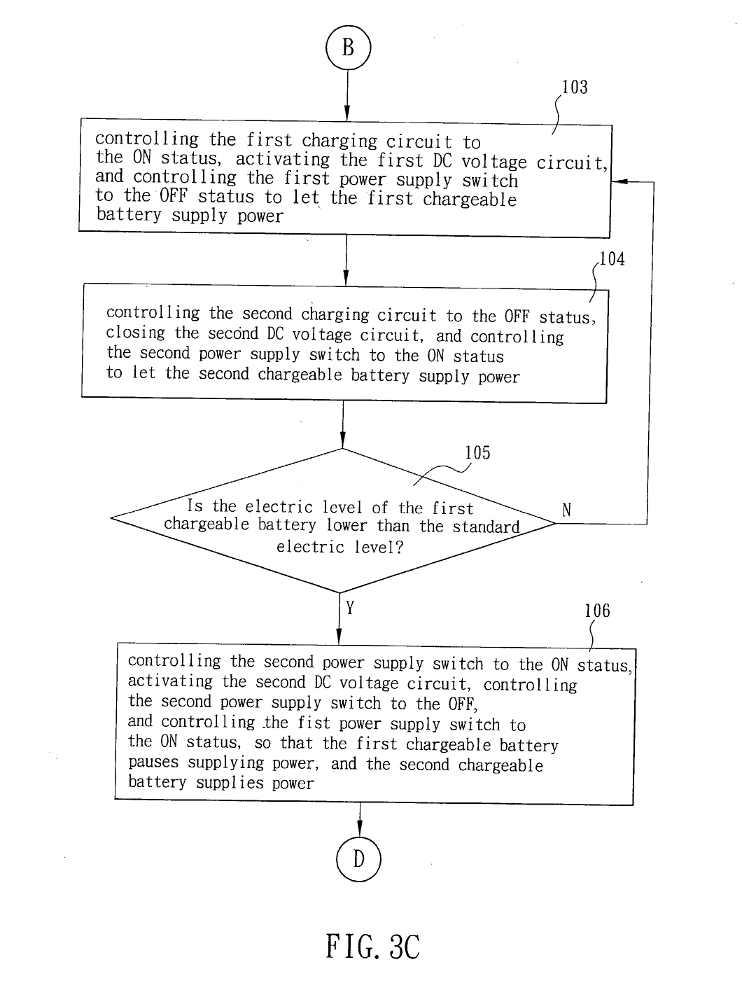

Please refer to FIGS. 3A, 3B and 3C. When the user uses the circuit 2 to supply power to the electronic device 3, the processing procedure of the microprocessor 21 comprises the steps of:

Step 101: determining if the electric level of the first and second chargeable batteries 27, 28 is lower than the minimum electric power of regular batteries; if yes, end the procedure, so that the user can perform other process. (such as replacing the battery), or else go to next step;

Step 102: determining if the electric level of the first chargeable battery 27 is higher than the electric level of the second chargeable battery 28; if yes, go to Step 103, or else go to Step 107;

Step 103: controlling the first charging switch 29 to the ON status, and activating the first DC voltage circuit 251 and controlling the first power supply switch 262 to the OFF status to supply power to the electronic device 3 by the first chargeable battery 27;

Step 104: controlling the second charging switch 210 to the OFF status, and closing the second DC voltage circuit 253 and controlling the second power supply switch 264 to the ON status to charge the second chargeable battery 28 by the charging circuit 23;

Step 105: determining if the electric level of the first chargeable battery 27 is lower than the standard electric level; if yes, go to the next step, or else go to Step 103;

Step 106: controlling the first power supply switch 262 and the second charging switch 210 to the ON status, and activating the second DC voltage circuit 253 and controlling the second power supply switch 264 to the OFF status, so that the first chargeable battery 27 pauses supplying power to the electric device 3, but the second chargeable battery 28 supplies power to the electric device 3, and then going to Step 101;

Step 107: controlling the first charging switch 29 to the OFF status and turning off the first DC voltage circuit 251 and controlling the first power supply switch 262 to the ON status, so that the charging circuit 23 charges the first chargeable battery 27;

Step 108: controlling the second charging switch 210 to the ON status and activating the second DC voltage circuit 253 and controlling the second power supply switch 264 to the OFF status, so that the second chargeable battery 28 supplies power to the electronic device 3;

Step 109: determining if the electric level of the second chargeable battery 28 is lower than the standard electric level; if yes, go to the next step, or else go to Step 107;

Step 110: controlling the first charging switch 29 to the ON status and the first power supply switch 262 to the OFF status, and activating the first DC voltage circuit 251 and controlling the second power supply switch 264 to the ON status, so that the second chargeable battery 28 pauses supplying power to the electronic device 3, but the first chargeable battery 27 supplies power to the electronic device 3, and then going to Step 101.

Such power charge and supply procedure is repeated to accurately control the power supply and maximize the utility of battery by the control of microprocessor.

While the invention herein disclosed has been described by means of specific embodiments, numerous modifications and variations could be made thereto by those skilled in the art without departing from the scope and spirit of the invention set forth in the claims.

What is claimed is:

1. A circuit for controlling battery charge and supply by microprocessor, comprising:
a microprocessor, being individually connected to a charging circuit, a DC voltage circuit, and a power supply circuit; said power supply circuit comprising a first power supply switch and a second power supply switch, and said first and second power supply switches also connecting to said microprocessor, thereby said microprocessor controlling said first and second power supply switches to an ON or OFF status;
a first chargeable battery and a second chargeable battery, being connected between said charging circuit and said DC voltage circuit, and said chargeable batteries being connected to said microprocessor such that said microprocessor detecting the electric level of said chargeable level, and said power supply circuit being connected to an electronic device such that when the microprocessor controlling said first power supply switch to the OFF status, said first chargeable battery supplying power to said electronic device; when said microprocessor controlling second power supply switch to the OFF status, said second chargeable battery supplying power to said electronic device;
a first charging switch and a second charging switch, being connected between said first and second chargeable batteries and said charging circuit respectively, and said first and second chargeable batteries connecting with said microprocessor such that said microprocessor respectively controlling said first and second charging switches to an ON or OFF status to respectively charge the first chargeable battery or the second chargeable by said charging circuit.

2. The circuit for controlling battery charge and supply by microprocessor of claim 1, wherein said DC voltage circuit comprising a first DC voltage circuit and a second DC voltage circuit; said first and second DC voltage circuits respectively connecting to said first and second chargeable batteries, such that the voltage of the electric power released by said first and second chargeable batteries being stabilized by said first and second DC voltage circuits.

3. The circuit for controlling battery charge and supply by microprocessor of claim 1, wherein said electronic device is a computer.

4. The circuit for controlling battery charge and supply by microprocessor of claim 1, wherein said power supply circuit comprises a first power supply circuit and a second power supply circuit; said power supply circuits respectively comprises a one-way current limit diode and a capacitor, wherein said diodes and said capacitors being connected in series, and said diodes preventing the current of the electronic device from flowing back to said first and second chargeable batteries to avoid the electric short circuit of said first and second chargeable batteries caused by the backflow of current.

5. The circuit for controlling battery charge and supply by microprocessor of claim 4, wherein said diodes are connected to a first power supply switch and a second power supply switch in series, and said first and second power supply switches are connected to said microprocessor, thereby said microprocessor controlling said first and second power supply switches to an ON or OFF status.

6. A method for controlling battery charge and supply by microprocessor, having a microprocessor connected to a charging circuit, a DC voltage circuit, and a power supply circuit; wherein a pair of chargeable batteries being set between said charging circuit and said DC voltage circuit, and said charging circuit connecting to said microprocessor, thereby when said microprocessor detecting the electric level of one of the chargeable batteries being larger than the electric level of the other chargeable battery, the power supply circuit being controlled to let the battery having a higher electric level supply the power, and charge the battery having a lower electric level until the detected electric level of the rechargeable battery supplying power being lower than the electric level of a standard electric level, then respectively controlling said charging circuit and power supply circuit to charge the rechargeable battery having an electric level lower than the standard electric level, and then the originally charged chargeable battery with full charges supplying power.

7. The method for controlling battery charge and supply by microprocessor of claim 6, wherein said microprocessor directly terminates its processing to allow battery replacement, when said microprocessor detects the electric level of said chargeable batteries being lower than the minimum electric level of a regular battery.
